(19) United States
(12) Patent Application Publication
(10) Pub. No.: US 2015/0011193 A1
(43) Pub. Date: Jan. 8, 2015

(54) METHOD AND APPARATUS FOR PROCESSING CONTACT LIST IN PORTABLE TERMINAL

(71) Applicant: Samsung Electronics Co., Ltd., Suwon-si (KR)

(72) Inventors: Sungjun KIM, Daegu (KR); Hyunsuk CHOI, Daegu (KR)

(21) Appl. No.: 14/300,730

(22) Filed: Jun. 10, 2014

(30) Foreign Application Priority Data
Jul. 3, 2013 (KR) 10-2013-0077495

(51) Int. Cl. H04M 1/725

(52) U.S. Cl. CPC H04M 1/72566; H04M 1/72583
USPC 455/414.1; 455/564

(57) ABSTRACT

A method and an apparatus for processing a contact list in a portable terminal are provided. A method of processing contact information of a portable terminal includes analyzing a schedule by analyzing contact information included in schedule information, re-arranging a subscriber display point of the contact list according to contact information included in the schedule information and displaying the contact list, and forming a communication link with a subscriber selected in the contact list and executing a contact. A schedule check and management operation of the portable terminal can be conveniently processed by only executing the contact application in which subscriber information is displayed with a list.

### CROSS-REFERENCE TO RELATED APPLICATION(S)

This application claims the benefit under 35 U.S.C. §119(a) of a Korean patent application filed on Jul. 3, 2013 in the Korean Intellectual Property Office and assigned Serial number 10-2013-0077495, the entire disclosure of which is hereby incorporated by reference.

### TECHNICAL FIELD

The present disclosure relates to a method and an apparatus for processing a contact list in a portable terminal

### BACKGROUND

A portable terminal includes a scheduling function, a contact function, or the like to enhance a user's convenience. When the user has input scheduling information such as a schedule, a task, an event, or the like, the scheduling function supports to manage the user's schedule by storing the input schedule information. When the user has input contact information such as a phone number, an e-mail, Social Networking Services (SNS), or the like, the contact function supports to execute a contact by using the input contact information. For example, the contact execution may include contacting another portable terminal by executing an application such as a text message, a messenger service, SNS, or the like. When there is a request for displaying the contact information, the contact information may be displayed as a list. In this event, the listed contact information is arranged and displayed in a batch scheme based on a first character of Language in ascending order or in descending order. A contact list may arrange and display the contact information as a list type that is collectively arranged and displayed alphabetically, based on a first character of Language in ascending order or in descending order, a frequently contacted person, or the like. When the contact list has been collectively arranged, a user must select receivers in the contact list one by one in order to transfer and notify a message to people corresponding to a schedule, which results in an inconvenience to the user. Further, it is inconvenient to find registered schedule information one by one after a schedule application is executed in order to identify or change an existing registered schedule. And even though there is a function for setting an alarm when registering a schedule, the function has a limitation in that the alarm can ring without considering a user's situation. Accordingly, there is a need for an improved apparatus and method for grouping and displaying a registered schedule and contact information according to the registered schedule when the contact list is displayed in the portable terminal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect the present disclosure is to provide a method and an apparatus for grouping and displaying a registered schedule and contact information according to the registered schedule when the contact list is displayed in the portable terminal. Another aspect of the present disclosure is to provide an apparatus and a method for performing a batch communication function with subscribers according to the grouped contact information.

Still another aspect of present disclosure is to provide a method and an apparatus for interconnecting schedule information stored in the portable terminal with contact information, displaying the interconnected information in the contact list, analyzing schedule information, arranging contact information including the schedule information by priority in the contact list and displaying the arranged schedule information with the schedule information when displaying the contact list.

In accordance with an aspect of the present disclosure, a method of processing contact information of a portable terminal is provided. The method includes analyzing a schedule by analyzing contact information included in schedule information, re-arranging a subscriber display point of the contact list according to contact information included in the schedule information and displaying the contact list, and forming a communication link with a subscriber selected in the contact list and executing a contact.

In accordance with another aspect of the present disclosure, an apparatus for processing contact information in a portable terminal is provided. The apparatus includes a display panel configured to display a schedule and a contact list, a touch panel configured to detect storing the schedule and detects a contact execution, and a controller configured to control to display contact information re-arranged according to a schedule, a priority and a time of the schedule at the top of the contact list after analyzing the schedule and re-arranging the contact information according to the schedule when detecting the contact list display.

The portable terminal according to an embodiment of the present disclosure may interconnect with a stored schedule and group and display a contact list depending on the stored schedule when displaying the contact list in a state of executing a contact application. Further, the portable terminal can group the contact information according to a schedule, a priority of a schedule, and time information of a schedule in sequence and display a contact information group in which the schedule, the priority of the schedule, and the time information of the schedule among the grouped contact information are high in an uppermost area of the contact list. The portable terminal may display contact information grouped according to a schedule together with a list of the previously registered contact information in contact information previously registered in the contract list. Therefore, a user can conveniently contact all members of a group by selecting grouped contact information. A schedule check and management operation of the portable terminal can be naturally and conveniently processed by only executing a friend list based social application such as a messenger without separately using a schedule alarm function or a schedule check and edit function. Further, a usability of a schedule function can increase.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a construction of a portable terminal according to an embodiment of the present disclosure;

FIG. 2 is a flowchart illustrating a process of re-arranging contact information in a portable terminal according to an embodiment of the present disclosure;

FIG. 3 illustrates an example of registering schedule information, such as by using the process of FIG. 2, according to an embodiment of the present disclosure;

FIG. 4 illustrates an example of schedule information and a contact list in which the contact information is grouped according to the schedule information, such as by using the process of FIG. 2, according to an embodiment of the present disclosure;

FIG. 5 is a flowchart illustrating a process of correcting a schedule in a state of displaying a schedule and a contact list grouped according to the schedule, such as by using the process of FIG. 2, according to an embodiment of the present disclosure;

FIG. 6 illustrates an example of correcting a schedule, such as by using the process of FIG. 5, according to an embodiment of the present disclosure;

FIG. 7 is a flowchart illustrating a process of executing a contact application, such as by using the process of FIG. 2, according to an embodiment of the present disclosure; and

FIG. 8 illustrates an example of executing a contact application, such as by using the process of FIG. 7, according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various embodiments of the present disclosure described in this specification and shown the drawings correspond to specific examples that are presented in order to explain technical contents of the present disclosure, and to help comprehend the present disclosure, but are not intended to limit the scope of the present disclosure. It is obvious to those skilled in the art to which the present disclosure pertains that other modified embodiments on the basis of the spirit of the present disclosure besides the embodiments disclosed herein can be carried out.

In various embodiments of the present disclosure, the term “contact application” denotes an application in which a list of subscribers that can communicate with a counterpart is displayed in a list form. The contact application may be a phone book application, a Social Network Service (SNS) application installed by a user, various messengers, and the like. In various embodiments of the present disclosure, a contact list may be a list in which contact information registered in a portable terminal is arranged and displayed when a user registers the contact information in the contact application. Further, the contact list may be a contact list in which contact information is grouped and arranged according to a schedule. The contact information of the contact list may be registered by being collectively arranged in a first character of Language in ascending order or in descending order. Contact information registered in the contact list may include a name, a picture, a phone number, a group name, a fixed schedule (e.g., a birthday), and the like. In the various embodiments of the present disclosure, the term “schedule information” denotes information registered in a schedule application. According to embodiments of the present disclosure, schedule information may include all information related to a variable schedule (e.g., a task, an objective, an appointment, or the like) that is limited to a specific time and a fixed (repeated) schedule (e.g., a birthday, an anniversary, or the like) that is not limited to a specific time. Further, when a fixed schedule (e.g., a birthday, an anniversary) is registered in contact information, schedule information corresponding to the fixed schedule in the contact information may be shared (registered) as schedule information of the schedule application. Therefore, schedule information related to the fixed schedule of the contact information may be automatically registered in the schedule application. In various embodiments of the present disclosure, the contact application displays a registered contact list by listing the contact information. Further, the contact application is interconnected with the schedule information when displaying the contact list and re-arranges and displays the contact information of the contact list according to contact information registered in the schedule information. When displaying the contact list, the portable terminal firstly displays (e.g., at a top of a display area in the contact list) contact information included in the schedule information together with schedule information (e.g., a title and time of schedule information) and displays general contact information following contact information having the schedule information. The term “general contact information” refers to information which does not have the schedule information and denotes contact information registered in the contact list.

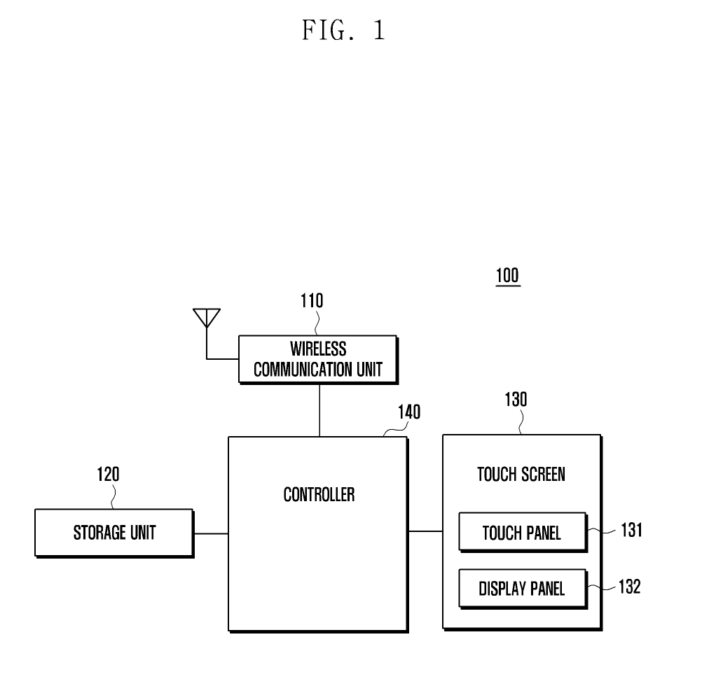

FIG. 1 is a block diagram illustrating a construction of a portable terminal according to an embodiment of the present disclosure.

Referring to FIG. 1, a portable terminal 100 may include a wireless communication unit 110, a storage unit 120, a touch screen 130 and a controller 140.

The wireless communication unit 110 performs a voice communication, a video communication or a data communication with an external device through a network under a control of the controller 140. The wireless communication unit 110 includes a wireless frequency transmission unit for upward converting and amplifying a frequency of a transmitted signal, and a wireless frequency reception unit for downward converting and low-noise amplifying a frequency of the received signal. Further, the wireless communication unit 110 may include a mobile communication module (e.g., Code Division Multiple Access (CDMA), Long Term Evolution (LTE), Wideband Code Division Multiple Access (WCDMA), or the like), a digital broadcasting module (e.g., a Digital Multimedia Broadcasting (DMB) module), a short range communication module (e.g., Wi-Fi) module, a Bluetooth module, and a Near Field Communication (NFC) module. Especially, when a user has selected a contact application by a group, the wireless communication unit 110 transmits or receives a message between grouped members according to a schedule when performing the contact application.

The storage unit 120 may store a program or commands for the portable terminal 100. For example, in an embodiment of the present disclosure, the storage unit 120 may store schedule information and contact information.

The touch screen 130 may include a touch panel 131 and a display panel 132. The touch panel 131 may be integrally configured with the display panel 132. Further, the touch panel 131 may detect a touch input and transmit a detected touch signal to the controller 140.

Meanwhile, the display unit 132 may include a display screen such as a Liquid Crystal Display (LCD), an Organic Light Emitted Diode (OLED), an Active Matrix Organic Light Emitted Diode (AMOLED) or the like. For example, in an embodiment of the present disclosure, the display unit 132 may arrange grouped contact information according to a schedule stored in the storage unit 120 and display a contact list.

The controller 140 may control an overall operation of components of the terminal 100. For example, in an embodiment of the present disclosure, the controller 140, when executing a contact, re-arranges and displays contact information of the contact list according to a registered schedule after analyzing the registered schedule. When the schedule information includes multiple pieces of contact information, the controller 140 may display a contact list into which the plurality of contact information is grouped with the schedule information (e.g., a schedule title and data/time information). In a state of displaying the grouped contact list according to the schedule, the controller 140 may execute a contact to an individually selected group member or all collectively selected members of the group when detecting a contact execution by a group. Herein, the controller 140 displays a contact list together with a registered schedule title in the contact list. When a selection of the schedule title has been detected, the controller 140 may control to correct the schedule information.

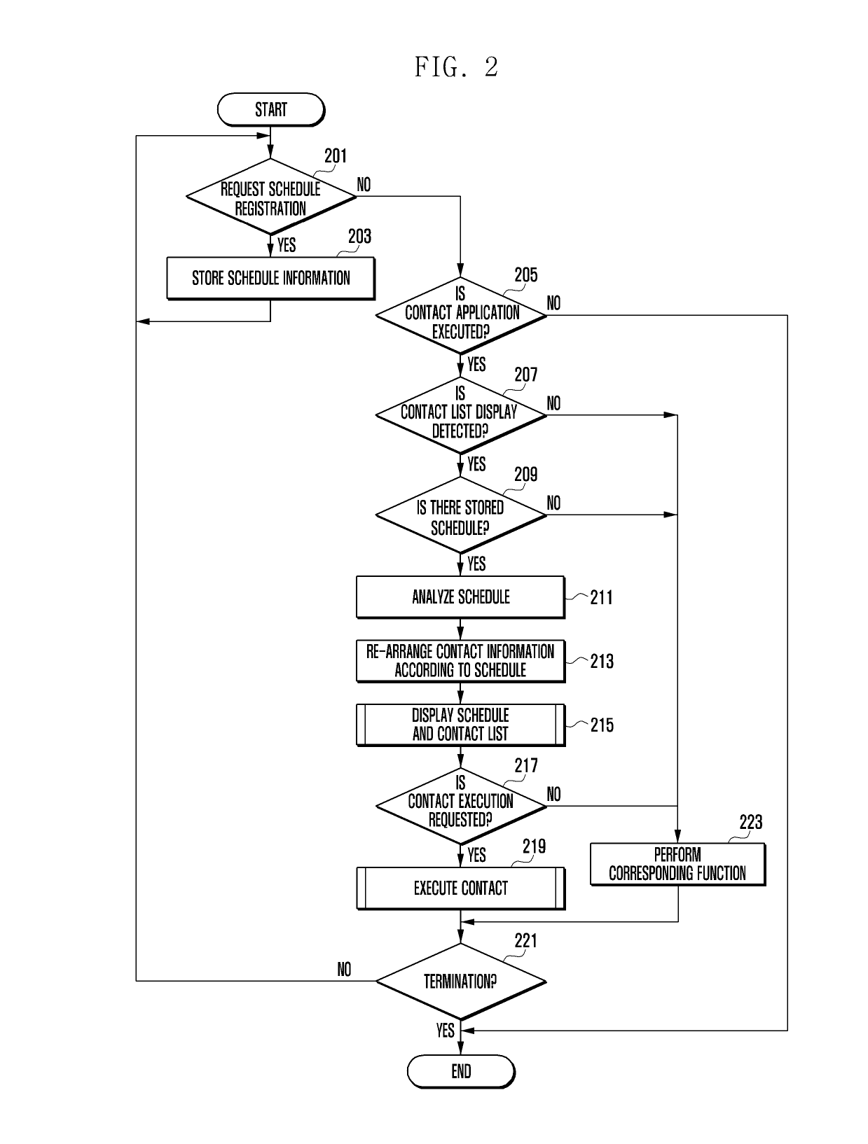

FIG. 2 is a flowchart illustrating a process of re-arranging contact information in a portable terminal according to an embodiment of the present disclosure.

Referring to FIG. 2, the controller 140 displays a contact list interconnected with schedule information. When detecting a requirement of displaying a contact list by performing a contact application, the controller 140 identifies contact information included in schedule information and re-arranges and displays contact information in the contact list after analyzing the schedule information of a set date (e.g., a today's schedule or a schedule from today to set date).

When executing the contact application, a process of grouping a contact list according to schedule information may be formed in a following order.

First, if it is determined that a request for schedule information registration has been detected in operation 201, the controller 140 may resister schedule information in operation 203. Herein, the schedule may be schedule information which a user registers in a scheduler and schedule information registered in contact information. The schedule information may include a title, date and time information, alarm information, a member (i.e., contact information) related to the schedule, a detail content of the schedule, and the like.

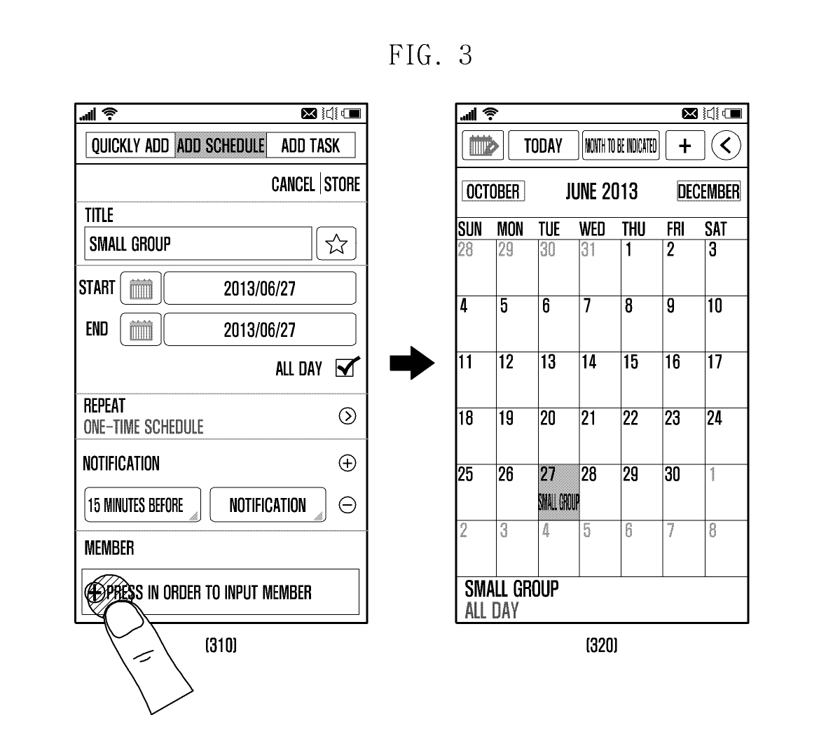

FIG. 3 illustrates an example of registering schedule information, such as by using the process of FIG. 2, according to an embodiment of the present disclosure.

Referring to FIG. 3, a screen 310 of FIG. 3 is an example of a screen for registering schedule information. The schedule information may include a schedule title, a schedule date, schedule notification, a schedule place, a schedule member, or the like. For example, as shown the screen 310, the schedule information may include title: small group, schedule date: 2013/6/27, schedule notification: notification 15 minutes before may be input. In a state as described above, when the schedule member selection has been detected, the controller 140 may control to select a member participating in a corresponding schedule in the contact list. The schedule member may be contact information registered in the contact list and one or more members may be registered by detecting a schedule member selection in the schedule information. When the schedule information registration has been detected, the controller 140 may display the registered schedule (e.g., a small group) to a corresponding date (e.g., Jun. 27, 2013) as shown a screen 320.

Referring again to FIG. 2, when a request for an execution of the contact application is generated, the controller 140 detects the request for the execution of the contact application in operation 205 and determines whether the request is for displaying the contact list in operation 207. The contact list is a list which is registering contact information. When it is determined in operation 207 that the request is not for displaying the contact list, the controller 140 may control to perform a function such as a conversation, a setting change, or the like in operation 223.

When a request for a display of the contact list has been detected in operation 207, the controller 140 analyzes the schedule information stored in the storage unit 120 in operation 209. The schedule information may be information registered by adding a schedule in the scheduler and schedule information registered in the contact application. Further, the schedule information may include the contact information. When there is not a stored schedule, the controller 140 may control to display a contact list collectively arranged in a first character of Language in ascending order or in descending order, in operation 223.

When it is determined in operation 209 that there is the stored schedule information, the controller 140 analyzes schedule information of set date (e.g., today's schedule information, a week-long schedule information, or the like) in operation 211 and re-arranges contact information of the contact list according to the analyzed schedule information in operation 213. When the contact information in the contact list is re-arranged, the controller 140 re-arranges the contact information to have a priority in an order of a set schedule (e.g., an anniversary such as a birthday, or the like), a date or time information in the schedule information. When the schedule information includes multiple pieces of contact information, corresponding contact information is grouped to corresponding schedule information. The controller 140 may display the stored schedule information and a contact list grouped according to the schedule information in operation 215.

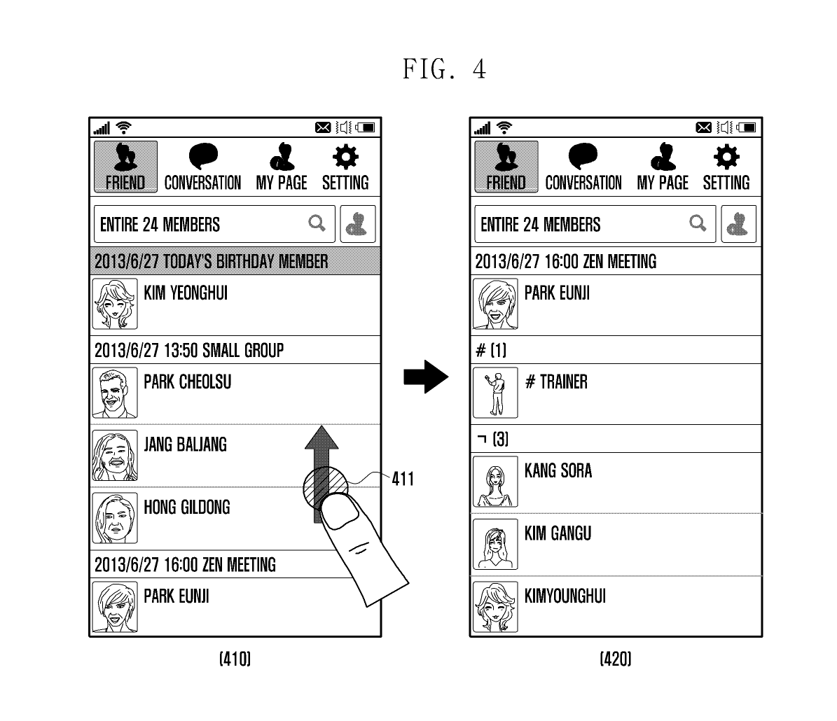

FIG. 4 illustrates an example of schedule information and a contact list in which the contact information is grouped according to the schedule information, such as by using the process of FIG. 2, according to an embodiment of the present disclosure.

Referring to FIG. 4, a screen 410 is an example of a screen of the stored schedule and the contact list in which the contact information is grouped according to a schedule in a state of executing a contact (e.g., a Chat on application).

The controller 140 may select a schedule display period by a unit of time when re-arranging the contact information according to the schedule and displaying the contact list. The unit of time is a period set to display a schedule during a set period, for example, one day, one week, one month, or the like.

It is assumed that in the screen 410, a schedule display period is set to one day and three schedules are stored in Jun. 27, 2013. In a state in which the three schedules are displayed, the controller 140 may display a schedule arranged by a time and a priority, and a contact list in which the contact information is re-arranged according to the schedule. When the contact information is arranged by a time, the controller 140 may arrange the contact information in the contact list in a stored schedule time order when registering a schedule. When the contact information is arranged by a priority, the controller 140 may determine schedule information stored in the contact information by the priority and display the schedule information by the priority in the contact list. When there is a fixed schedule such as a birthday or an event in the contact information, the controller 140 arranges and displays the schedule such as the birthday or the event to come to the top level in the contact list. Further, the controller 140 controls the priority to be changed and displayed by a user. When displaying the schedule and the contact list in which the contact information is re-arranged according to the schedule, the controller 140 may display the schedule and the contact list by highlighting with a color or an effect. For example, a darkening effect may be displayed as shown in “Today's birthday member” in the screen 410. Further, the controller 140 may control a kind of color or effect to be variously changed.

Further, when the plurality of contact information is included in one schedule in a case of re-arranging the contact information according to the schedule information, the contact information is grouped and displayed as indicated by “small group” of the screen 410.

In a state in which the contact information is grouped and displayed, when a drag from bottom to top as indicated by reference numeral 411 at a point at which contact information lastly re-arranged among the contact list including the contact information re-arranged according to the schedule is displayed has been detected, the controller 140 moves and displays the contact list. In this event, the controller 140 collectively arranges and displays the contact information at the bottom of the contact information, re-arranged according to the schedule, such as by a first character of Language in ascending order or in descending order as shown in the screen 420. For example, in the case of “Kim Yeonghui” among the multiple pieces of contact information, the controller 140 may display the contact information re-arranged according to the schedule in the contact list in the screen 410. In addition, the controller 140 may arrange and display contact information (e.g., “Kim Yeonghui”) in the contact list at least one in a first character of Language in ascending order or in descending order displayed subsequent to the bottom of the contact list grouped according to the schedule.

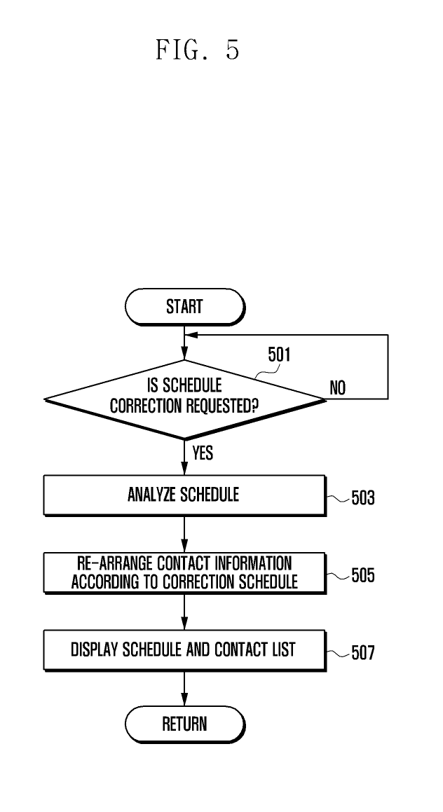

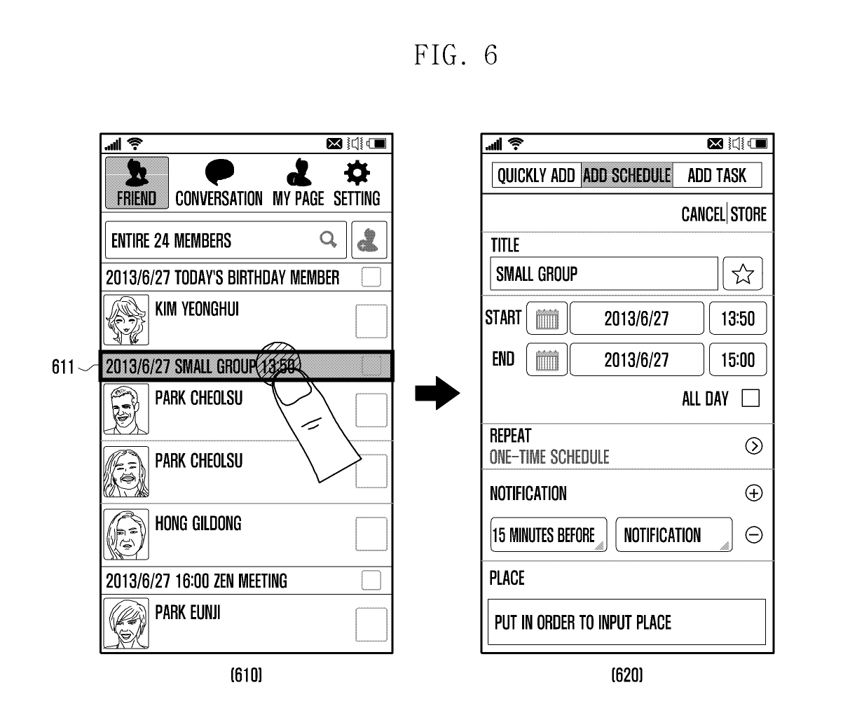

FIG. 5 is a flowchart illustrating a process of correcting a schedule in a state of displaying a schedule and a contact list grouped according to the schedule, such as by using the process of FIG. 2 according to an embodiment of the present disclosure. FIG. 6 illustrates an example of correcting a schedule, such as by using the process of FIG. 5, according to an embodiment of the present disclosure.

Referring to FIGS. 5 and 6, the controller 140 may detect a request for a schedule correction in operation 501. A screen 610 of FIG. 6 is an example of a screen on which a request for a schedule correction is detected. The screen 610 is an example of a screen on which a stored schedule and a contact list in which contact information is re-arranged according to the schedule are displayed. In a state of displaying the schedule and the contact list, when a selection (e.g., a touch, a tap) for a title of the stored schedule area 611 has been detected, the controller 140 displays the selected schedule correction screen as shown in a screen 620. Therefore, the controller 140 may correct a schedule and contact information in the selected schedule correction screen.

When the schedule correction has been completed, the controller 140 analyzes the schedule in operation 503, re-arranges the contact information according to the schedule correction in operation 505, and displays the contact list in which the contact information is re-arranged according to the corrected schedule in operation 507. When there are multiple pieces of the contact information, the controller 140 may group the contact information of the contact list and display the contact information.

Referring again to FIG. 2, in a state of displaying the schedule and the grouped contact list according to the schedule, the controller 140 determines whether a request for a contact execution is detected in operation 217. When the request for the contact execution has been detected, the controller 140 may execute a contact to grouped subscribers in operation 219. That is, in a state of displaying the contact list in which the contact information is grouped, when an option selection which collectively selects the grouped contact information has been detected, the controller 140 executes the contact. Herein, the option selection which collectively selects the grouped contact information may be an event which selects a schedule title area displayed in the contact list by grouping the contact information according to the schedule.

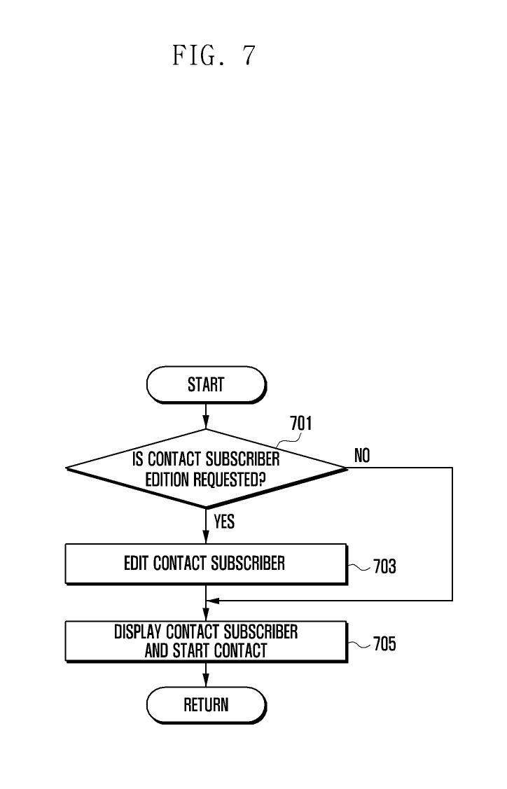

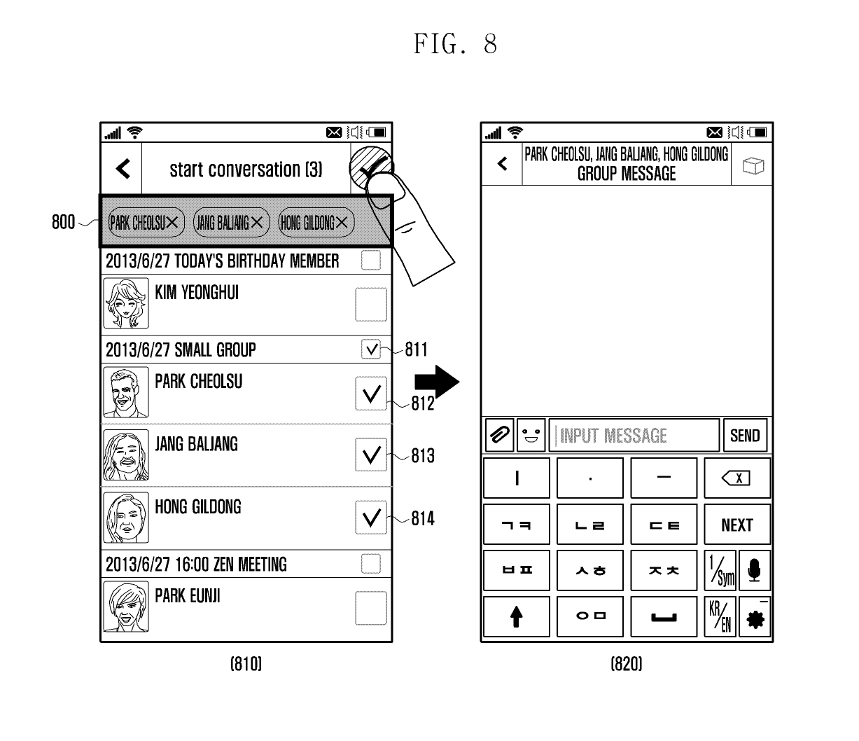

FIG. 7 is a flowchart illustrating a process of executing a contact application, such as by using the process of FIG. 2, according to an embodiment of the present disclosure. FIG. 8 illustrates an example of executing a contact application, such as by using the process of FIG. 7, according to an embodiment of the present disclosure.

Referring to FIGS. 7 and 8, a screen 810 is an example of a screen for collectively selecting grouped contact information in a screen on which a contact application (e.g., chat on) is executed and executing a contact. It is assumed that a schedule display period is set to one day and three schedules are stored in Jun. 27, 2013 as shown in the screen 810. The controller 140 may display contact information re-arranged according to three schedules (today's birthday member, small group, ZEN meeting). A “small group” includes multiple pieces of contact information so that the controller 140 can group and display the contact information. It is assumed that the contact information included in “small group” is Park Cheolsu, Jong Baljang, HongGildong. When a selection of an option (e.g., a check box) 811, which collectively selects the contact information of grouped “small group” has been detected, the controller 140 may display, as indicated by reference numeral 800, a subscriber included in schedule information of the small group and execute the contact. The subscriber is a subscriber of the contact application and a subscriber corresponding to the contact information re-arranged in “small group”.

Referring to FIG. 7, the controller 140 may detect a request for a contact subscriber editing in operation 701. Herein, the request for the contact subscriber editing may be a request to add or remove some subscribers in the contact information collectively selected in order to execute a contact. The request for the contact subscriber editing may be performed through each subscriber name and an “X” mark which are at the top of the contact list as shown in the screen 810. Further, the request for the contact subscriber editing may be performed through options (e.g., a check box) 812, 813 and 814, which can select or remove the subscribers, on the right side of the contact information. When a selection of the option 811 which collectively selects contact information has been detected, the selected subscriber may be displayed on a contact execution screen. When a de-selection of some subscribers among collectively selected subscribers has been detected, the selected subscribers may be only displayed.

Through the process as described above, the controller 140 edits the contact subscriber in operation 703 and may display the selected contact subscribers and start a contact as shown in a screen 820 in operation 705.

Referring again to FIG. 2, when a termination of a contact has been detected in operation 221 after executing the contact, the controller 140 processes the termination. The termination process may be a conversation termination of the contact application and a termination of the contact application.

A portable terminal according to various embodiments of the present disclosure may provide a social application function using a calendar module, a contact module and a friend list and re-arrange and display the contact information of the contact list according to the contact information included in the schedule information when displaying the contact list. The portable terminal may be shared (e.g., interconnected) and operate input information of the calendar module and the contact module with a social application using the contact list. The schedule information may include all data related to the schedule such as a schedule title, a schedule date, a schedule time, a schedule member, a schedule place, or the like and all data items of inner contact.

When executing a contact list based social application, the portable terminal brings previously input data of the calendar module and the contact module in a process of updating the contact information of the contact list in real time and selects proper common data through a process of comparing and analyzing data included in the contact list based social application. That is, the portable terminal interconnects specific information of the calendar module and the contact module with the contact list based application and applies changes of the group according to changes of the schedule information and the contact information to generating a group in the contact list based social application in real time. In addition, the contact list based application can immediately execute, identify and edit information of a schedule application through a group title interconnected with a schedule. The data changed in the schedule application is interconnected with the contact list based application in real time.

Herein, a social application of the contact list refers to all applications, which can communicate with a counterpart by registering the counterpart as a friend and display the registered friends in a list type, such as various messengers, a Social Network Service (SNS) application, or the like.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that other various changes in form and details may be made therein without departing from the spirit and scope of the present disclosure as defined by the appended claims and their equivalents.

What is claimed is:

1. A method of processing contact information of a portable terminal, the method comprising:
analyzing a schedule by analyzing contact information included in schedule information;
re-arranging a subscriber display point of the contact list according to contact information included in the schedule information and displaying the contact list; and
forming a communication link with a subscriber selected in the contact list and executing a contact.

2. The method as claimed in claim 1, wherein the displaying of the contact list further comprises:
displaying a corresponding schedule and contact information in the contact list when the contact information is included in the schedule information; and
when the schedule information includes multiple pieces of contact information, grouping multiple pieces of corresponding contact information according to a corresponding schedule and displaying the grouped multiple pieces of contact information in the contact list,
wherein the contact list displays contact information of a subscriber included in the schedule and general contact information in sequence.

3. The method as claimed in claim 2, wherein the displaying of the contact list further comprises displaying contact information of a subscriber having a fixed schedule in the contact list when there is the subscriber having the fixed schedule in the schedule,
wherein the contact list lists and displays the contact information of the subscriber having the fixed schedule, and contact information of a subscriber included in the schedule and general contact information in sequence.

4. The method as claimed in claim 2, wherein the displaying of the contact list further comprises:
when a selection of a schedule title area has been detected, displaying a screen on which the selection of the schedule has been detected; and
when the schedule and/or the contact information is corrected in the screen displaying the schedule, re-arranging and displaying the contact information of the contact list according to the corrected schedule.

5. The method as claimed in claim 2, wherein the schedule information includes a schedule and contact information stored in a scheduler and new contact information is addible when registering the schedule.

6. The method as claimed in claim 2, wherein the contact information includes at least one of phone book information, subscriber information of a Social Network Service (SNS) application, and subscriber information of a messenger.

7. The method as claimed in claim 2, wherein the displaying of the contact list comprises displaying the schedule and the contact list arranged according to an order of a display priority or schedule time information.

8. The method as claimed in claim 2, wherein the displaying the corresponding schedule is applied to at least one of a color and an effect.

9. The method as claimed in claim 2, wherein the displaying of the contact list comprises displaying the schedule and the contact list with a set displaying period.

10. The method as claimed in claim 2, wherein the displaying of the contact list comprises arranging and displaying the contact information re-arranged according to the schedule and displaying the contact list at least one in an ascending order or an descending order based on the first character of language at the bottom when displaying the schedule and the contact list.

11. The method as claimed in claim 2, wherein the executing of the contact comprises:
executing a batch contact with grouped subscribers when collectively selecting the grouped contact information; and
executing a contact by adding/removing the collectively selected subscribers.

12. An apparatus for processing contact information in a portable terminal, the apparatus comprising:
a display panel configured to display a schedule and a contact list;
a touch panel configured to detect storing the schedule and to detect a contact execution; and
a controller configured to control to display contact information re-arranged according to a schedule, a priority and a time of the schedule at the top of the contact list after analyzing the schedule and re-arranging the contact information according to the analyzed schedule when detecting the contact list display.

13. The apparatus as claimed in claim 12, wherein the controller is further configured to control to display a corresponding schedule and contact information in the contact list when the contact information is included in the schedule information, to group and display multiple pieces of corresponding contact information when the contact information is included in the schedule information and to cause the contact list to display contact information re-arranged according to the schedule and general contact information in sequence.

14. The apparatus as claimed in claim 13, wherein the controller is further configured to control to execute a batch contact with grouped contact information when detecting a collective selection of the plurality of grouped contact information and at least one of add and remove other contact information to or from the plurality of contact information which is collectively selected, wherein the contact information refers to a contact application subscriber.

15. The apparatus as claimed in claim 12, wherein the controller is further configured to control to display contact information having a fixed schedule, contact information of a subscriber included in the schedule and general contact information in sequence at a time of displaying the contact list when there is a subscriber having the fixed schedule in the schedule and to arrange the contact information according to a display priority or a schedule time information when displaying the schedule and the contact list.

16. The apparatus as claimed in claim 12, wherein the controller is further configured to control to display a schedule screen when detecting a selection of a schedule title area, to correct the schedule and/or the contact information and to re-arrange the contact information according to the corrected schedule when displaying the schedule and the contact list by detecting the contact list display.

17. The apparatus as claimed in claim 12, wherein the controller is further configured to control to include a schedule and contact information stored in a scheduler in the schedule information, to add the contact information to the schedule and to include at least one of phone book information, Social Network Service (SNS) subscriber information, and messenger information in the contact information.

18. The apparatus as claimed in claim 12, wherein the controller is further configured to control to set a period of displaying the schedule and the contact information when displaying the schedule and the contact information re-arranged according to the schedule and to give at least one of a color and an effect to the schedule when displaying the contact list.

19. The apparatus as claimed in claim 12, wherein the controller is further configured to display the contact information re-arranged according to the schedule and to display the contact list at least one in an ascending order or an descending order based on the first character of language at the bottom of the contact list when displaying the schedule and contact list.
